(19) United States
(12) Patent Application Publication
(10) Pub. No.: US 2021/0017942 A1
(43) Pub. Date: Jan. 21, 2021

(54) METHOD FOR MANUFACTURING A PLASTIC CONDUIT SUBJECTED TO AN INNER RELATIVE PRESSURE AND ASSOCIATED CONDUIT

(71) Applicant: AKWEL SA, Champfromier (FR)

(72) Inventors: Pascal GUERRY, Seppois-le-haut (FR); Patrick COUTIER, Chatillon en Michaille (FR)

(73) Assignee: AKWEL SA, Champfromier (FR)

(21) Appl. No.: 17/019,420

(22) Filed: Sep. 14, 2020

Related U.S. Application Data
(63) Continuation of application No. 16/049,045, filed on Jul. 30, 2018, now abandoned.

(30) Foreign Application Priority Data
Jul. 28, 2017 (FR) 17/57190

(51) Int. Cl. F02M 69/46; B29C 45/14; F02M 55/02

(52) U.S. Cl. CPC F02M 69/465; B29C 45/14065; B29C 45/14336; B29L 2023/22; B29C 45/14598; F02M 2200/8046; B29C 2045/14131; F02M 55/025

(57) ABSTRACT

A plastic injection rail, subjected to an inner relative pressure for an engine, includes: a conduit body; a plug; and a junction part overmolded within a contact area defined by portions of the plug and the end of the conduit body. The junction part can fixedly attach the plug into the end of the body, and includes a first portion arranged around the contact area, and a second portion within a space between the conduit body and plug. The plug has a hollow projection that extends toward the plug head. The plug body includes hollow rings including a primary ring arranged at the level of the free end of the plug body and secondary rings arranged between the primary ring and plug head. The junction part presents a generally cylindrical shape formed by rings including a primary ring closest to the contact area, and secondary rings.

This is a Continuation of U.S. patent application Ser. No. 16/049,045 filed Jul. 30, 2018, which claims the benefit of French Application No. 17/57190 filed Jul. 28, 2017. The disclosures of the prior applications are hereby incorporated by reference herein in their entireties.

The invention concerns the automotive industry, in the field of fluid transfer. More specifically, the invention relates to the design and manufacture of a conduit, preferably made of a thermoplastic, subjected to a high inner relative pressure, and for which particulate cleanliness is pursued.

In the present application, the example of a petrol injection rail is used to illustrate this invention. Of course, the present invention is not limited to injection rails and may be applied to any type of plastic conduit subjected to a high inner relative pressure, for example (quarter-wave, half-wave) resonators, Helmholtz resonators or silencers formed by a cavity and by multiple «necks» on petrol supply hoses (8 bars) or on air supply hoses at the level of the air supply line downstream of the turbocharger which must resist backfires (2 to 10 bars). These resonators often consist of cylindrical-shaped hollow bodies in communication via «necks» with hoses conveying the fluid in which pressure pulsations or impulses should be dampened. These hollow bodies forming the volume of the resonator are closed by plugs. The necks in a resonator consist of conduits connecting the portion to be dampened and the volume of the resonator.

Injection rails for petrol engines must resist an internal pressure in the range of 8 bars, and have large internal volumes configured to reduce the pressure pulsations during the injection. Conventionally, these injection rails may comprise a hollow body, called rail body, and a plug configured to close an end of the rail body. Injection rails are generally made of thermoplastic materials and preferably of a polyamide for reasons related to resistance and mechanical strength.

There are several possibilities for assembling the rail body with the plug.

Indeed, the hollow body and the plug are generally secured by a vibration welding process. However, this welding process creates impurities, such as plastic matter particles pulled off by the friction between the components to be welded, which often requires an additional washing operation after welding before being able to use these rails on vehicles.

According to a known solution, it is possible to use a method of assembly by overmolding, which allows overcoming the aforementioned drawbacks and does not require any additional welding operation. However, this type of process cannot be carried out for all types of injection rails and in particular for 8-bar rails which must be made of a polyamide for reasons related to mechanical strength of the assembly. Indeed, in the conventional overmolding processes, there is always a matter inhomogeneity between the overmolding portion and the overmolded portion, due to an insufficient supply of heat and pressure during the overmolding phase, this inhomogeneity creating fragile areas and promoting the breakage of the overmolded part. In this instance, the polyamide has a high and narrow melt point: the polyamide starts melting at substantially 220° C., becomes fluid at substantially 260° C. and is injected at substantially 300° C. In order to have a homogeneous interface between the overmolding portion and the overmolded portion, the temperature of the overmolded portion should rise to substantially 260° C. while taking into account that said overmolded portion has a temperature in the range of 100° C. when the latter is placed into the cavity of the mold in order to be overmolded. Yet, the overmolding portion should not exceed 300° C. and the temperature of the overmolded part should rise from 100° C. to 260° C. with an overmolded portion at 300° C., which represents a working range of 40° C. for bringing the two portions into contact, which is not sufficient, in general, for having a strong and tight weld and a homogeneous interface.

The invention aims at overcoming all or part of the aforementioned drawbacks.

An object of the invention is a method for manufacturing an injection rail subjected to an inner relative pressure,

wherein said method comprises the following steps of:
Providing a conduit body, for example an injection rail body, comprising at least one end to be closed,
Providing a plug shaped so as to close the end of the conduit body,
Assembling the plug into the end of the conduit body,
Positioning the assembly within a mold cavity in which an overmolding area is at least contiguous with a contact area defined by a portion of the plug and a portion of the end of the conduit body which are in contact with each other, the overmolding area being shaped so as to delimit the shape of a junction part configured to fixedly attach the plug into the end of the conduit body,
Filling the overmolding area by matter injection in order to form the junction part, wherein the overmolding area comprises a matter injection inlet coming out on the contact area.

The use of overmolding in such a method according to the invention allows obtaining a higher product cleanliness than is the case with the welding processes. In addition, overmolding the junction part at the level of the contact area between the conduit body and the plug allows promoting the adhesion of the conduit body with the plug by melting this contact area using the heat of the matter injected for overmolding.

According to an embodiment of the invention, the injection rail is made in plastic material.

According to an embodiment of the invention, the conduit is an injection rail for a petrol engine.

According to an embodiment of the invention, the overmolding area extends at least around the contact area.

According to an embodiment of the invention, the assembly of the plug with the conduit body is achieved by interlocking the plug into the end of the conduit body.

According to an embodiment of the invention, the assembly is held laterally by a first mold metallic portion and by a second mold metallic portion each being arranged at one side of the assembly.

According to an embodiment of the invention, the assembly is further held by a third mold metallic portion engaged at least partially into the plug. Advantageously, the third metallic portion fits into the plug so as to support the assembly during the overmolding of the junction part in order to avoid the collapse of the assembly under the overmolding pressure.

According to an embodiment of the invention, the overmolding area comprises a matter injection inlet opening into the contact area.

When the matter fills the cavity, the matter is very hot, the more the matter flows in and fills the cavity, the more the temperature decreases and loses its capacity to melt the plastic surfaces in contact with it. Thus, the injection inlet should be the closest to the melting area which corresponds to the contact area between the plug and the conduit body.

In addition, as long as the part is not completely filled, hot molten matter, coming directly from the injection screw, circulates by the matter end area. Hence, in this area and during the filling period, a high temperature prevails which promotes the melting of the contact area.

According to an embodiment of the invention, the overmolding area further extends at least partially out of the contact area so as to form a matter excess, which allows enlarging the volume of the overmolding area and therefore lengthening the matter filling period so as to promote the melting of the contacts between the plug and the conduit body for a better adhesion between the different components of the conduit.

Preferably, the overmolding area extends beyond the plug over a peripheral portion of the plug. Thus, the matter volume is larger, which allows lengthening the filling period so as to promote the melting of the contact area.

According to an embodiment of the invention, the overmolding area presents a generally annular, cylindrical, or helical shape.

According to a feature of the invention, the overmolding area extends either outside the contact area, or inside the contact area or both inside and outside the contact area. Thus, when the overmolding area extends both outside and inside the contact area, the mechanical strength of the conduit body/plug assembly is better. Furthermore, the matter inclusion within the contact area allows promoting the melting of said contact area, thereby improving the adhesion of the conduit body, the plug and the junction part.

According to an embodiment of the invention, the matter used for overmolding the junction part is a thermoplastic material, preferably a polyamide charged with fibers, such as polyamide 66 or polyamide 6. The use of a polyamide allows achieving an interesting tradeoff between the cost of the part and the resistance of the latter, because the contact temperature of the overmolded matter with the conduit body and the plug should be high yet without degrading the overmolded matter.

According to an embodiment of the invention, the method comprises an additional step of removing a matter excess forming a bead.

Advantageously, the additional step is carried out through a mechanical operation such as cutting with a tool, for example a cutter or a mill, or the same, the tool may be integrated and actuated upon opening of the mold as of the ejection phase.

Another object of the invention is also a plastic injection rail subjected to an inner relative pressure, for an engine obtained by the manufacturing method according to the invention, wherein the injection rail comprises at least:
a conduit body having an end to be closed,
a plug closing said end of the conduit body,
a junction part overmolded within a contact area defined by a portion of the plug and a portion of the end of the conduit body which are in contact with each other, said junction part being configured to fixedly attach the plug into the end of the conduit body, the junction part comprising at least at least one first portion arranged around the contact area of the plug and of the conduit body and one second portion included within at least one space created between the conduit body and the plug.

According to an embodiment of the invention, the conduit body comprises an application surface on which a fluid pressure may be applied, said application surface is a circular surface whose center is arranged on the middle longitudinal axis X-X of the conduit body within the inner volume of the conduit body and whose perimeter corresponds to a diameter of the conduit body. Thus, the smaller the application surface, the lower will be the stress exerted on said surface.

According to an embodiment of the invention, the perimeter of the application surface corresponds to the outer diameter of the conduit body or the inner diameter of the conduit body or a diameter comprised between the outer diameter and the inner diameter of the conduit body.

According to an embodiment of the invention, the conduit has a non-circular section, for example a substantially oval or rectangular section.

According to an embodiment of the invention, the plug comprises a plug body comprising an end on which a plug head is formed.

According to an embodiment of the invention, the plug body further comprises a free end opposite to the plug head.

According to an embodiment of the invention, the plug body is configured to be inserted into the end of the conduit body.

According to an embodiment of the invention, the head of the plug presents a shape matching with the shape of the end of the conduit body.

According to an embodiment of the invention, the plug body comprises at least one crenellation, preferably a plurality of crenellations. The crenellation(s) are shaped to reinforce the mechanical strength of the plug with the conduit body.

According to an embodiment of the invention, the plug body comprises at least one projection having at least one hollow ring such as a circumferential groove.

Advantageously, the projection allows creating a space configured to house a portion of the material configured to enable the overmolding of the junction part. Thus, once the overmolding is completed, a portion of the junction part is housed within the projection and has the shape of said projection.

According to an embodiment of the invention, the projection may be annular, cylindrical, or helical extending from a free end of the plug body toward the plug head.

According to an embodiment of the invention, the projection comprises at least one hollow ring, such as a circumferential groove.

According to another embodiment of the invention, the projection comprises a plurality of hollow rings including a primary ring arranged at the level of the free end of the plug body and secondary rings arranged between the primary ring and the plug head.

According to an embodiment of the invention, the conduit body comprises at least one recess.

According to an embodiment of the invention, the at least one recess is formed at the level of the end configured to be equipped with the plug.

According to an embodiment of the invention, the at least one recess of the conduit body is positioned at least partially opposite the projection formed on the plug. Thus, during the overmolding of the junction part, the material passes via the recess and fills the projection created on the plug.

According to an embodiment of the invention, the conduit body further comprises at least one second recess arranged between two rings of the projection having a plurality of rings. Once filled, said second recess forms a junction between said two rings.

According to an embodiment of the invention, the conduit body comprises a plurality of recesses each arranged between two adjacent rings of the projection. The recesses arranged between two rings enable an additional grip of material between the conduit body and the plug.

According to an embodiment of the invention, the junction part is overmolded so that at least one first portion of the junction part is arranged around the contact area of the plug and of the conduit body.

According to another embodiment of the invention, the junction part is at least partially formed between the plug and the end of the conduit body, and preferably between the plug head and the end of the conduit body.

According to an embodiment of the invention, the overmolded junction part further comprises a second portion included within at least one space created between the conduit body and the plug. This inclusion allows reinforcing the mechanical strength of the assembly.

According to an embodiment of the invention, the junction part has an annular shape.

According to another embodiment of the invention, the junction part has a generally cylindrical shape comprising a plurality of rings including a primary ring configured to ensure sealing.

According to an embodiment of the invention, the junction part further comprises secondary rings.

According to an embodiment of the invention, each ring of the plurality of rings is connected to an adjacent ring by a connecting member.

According to an embodiment of the invention, the secondary rings form a continuous helix. The helix allows having a longer flow than is the case with several rings and for the same bulk and the same mass of injected matter.

According to an embodiment of the invention, the plastic conduit is an injection rail for an engine preferably obtained by the manufacturing method according to the invention, comprising at least one rail body corresponding to the conduit body.

The invention will be better understood, thanks to the description hereinafter, which relates to embodiments of an injection rail considered for illustrating the plastic conduit according to the present invention. The embodiments are provided as non-limiting examples and explained with reference to the appended schematic figures. The appended schematic figures are listed herein below:

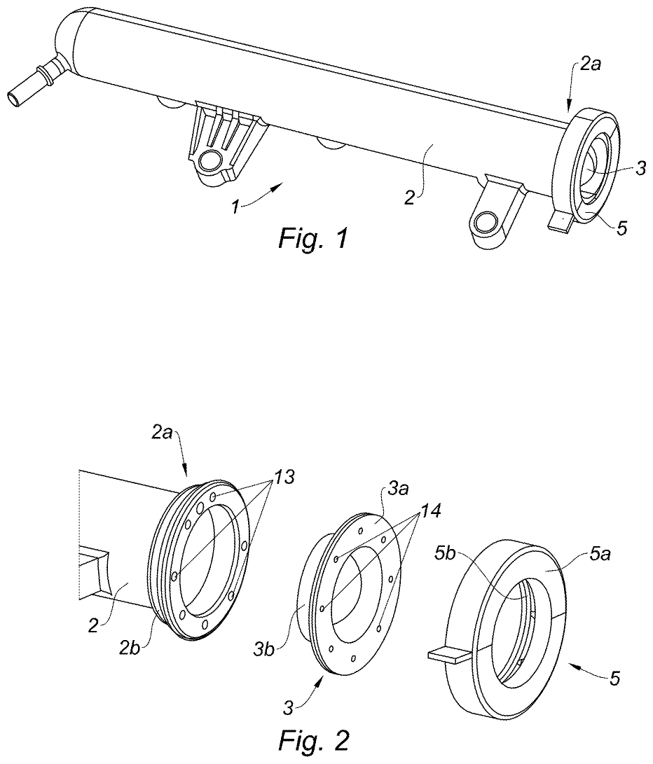

FIG. 1 is a perspective view of the injection rail according to a first embodiment according to the invention,

FIG. 2 is an exploded perspective view of the end of the rail illustrated in FIG. 1,

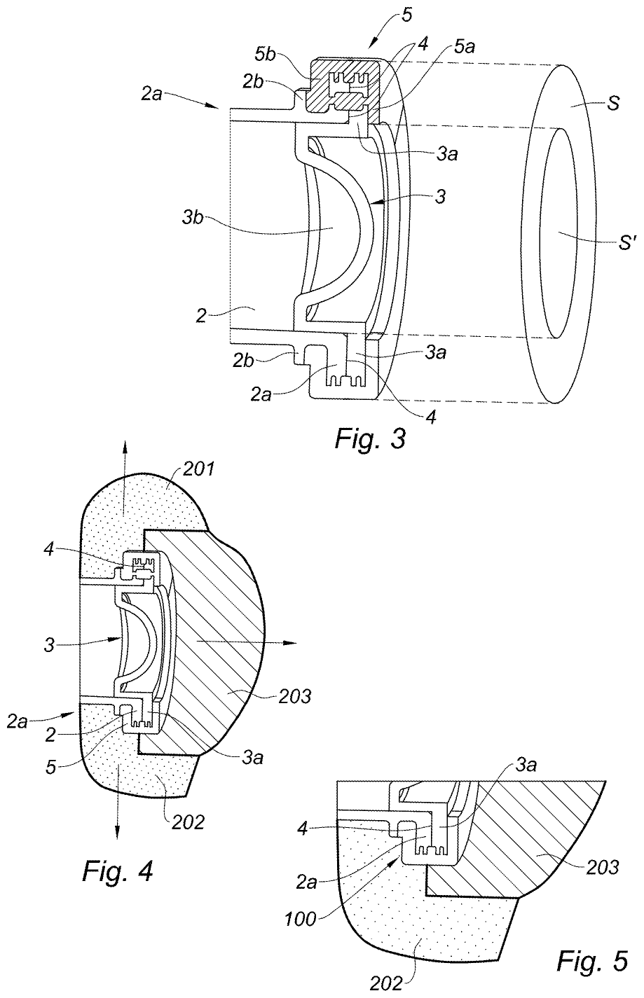

FIG. 3 is a sectional view of the end of the rail according to the first embodiment,

FIGS. 4 and 5 are schematic illustrations of steps of the method for manufacturing the injection rail according to the first embodiment,

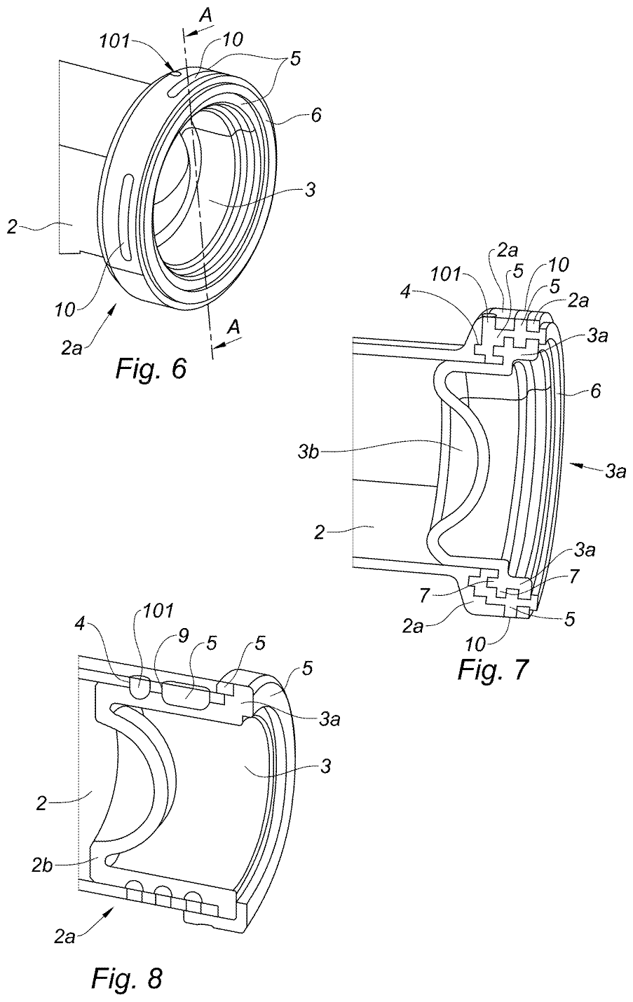

FIG. 6 is a perspective view of the end of the injection rail according to a second embodiment,

FIG. 7 is a sectional view according to the axis A-A of the end of the injection rail according to a second embodiment,

FIG. 8 is a sectional view of the end of the injection rail according to a third embodiment,

FIG. 9 is a perspective view of the junction part according to the third embodiment of the injection rail according to the invention,

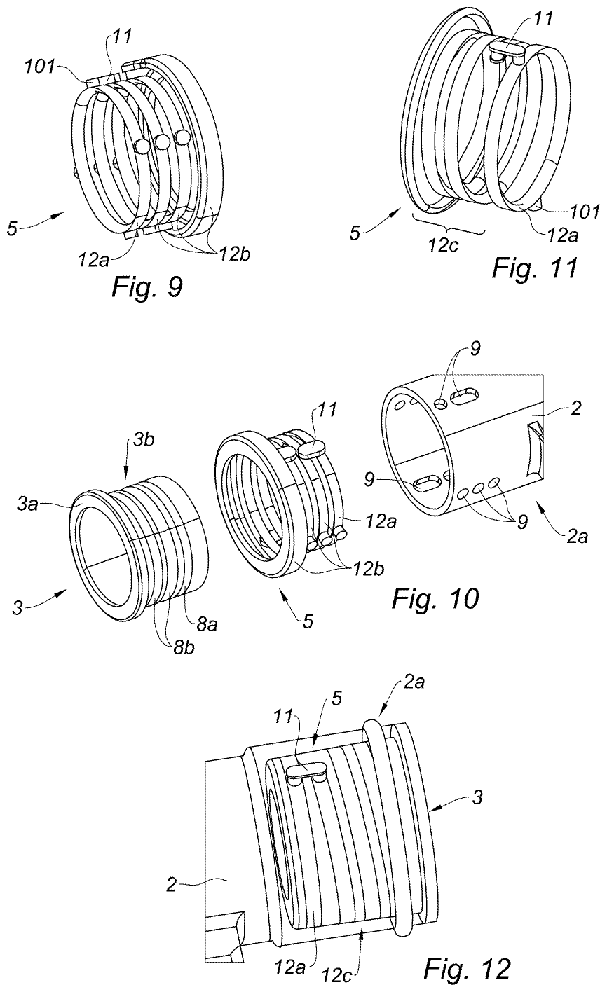

FIG. 10 is an exploded perspective view of the end of the injection rail according to the third embodiment,

FIG. 11 is a perspective view of the junction rail according to the fourth embodiment of the injection rail according to the invention,

FIG. 12 is a perspective view of the end of the injection rail according to the fourth embodiment.

Regardless of the embodiment, the method for manufacturing the injection rail 1 comprises at least one step of providing a rail body or conduit body 2, comprising at least one end 2a to be closed, a step of providing a plug 3 shaped so as to close the end 2a of the rail body 2, a step of assembling the plug 3 into the end 2a of the rail 2, and a step of overmolding a junction part 5 configured to fixedly attach the plug 3 into the end 2a of the rail body 2.

More specifically and regardless of the embodiment, in this method, the assembly consists in interlocking the plug 3 into the end 2a of the rail body 2. Furthermore, subsequently to the assembly of the plug 3 with the rail body 2, said assembly is positioned in a mold, said assembly being held laterally on the one side by a first metallic portion and on the other side by a second metallic portion. In addition, a third metallic portion is engaged at least partially into the plug 3 in order to avoid the assembly collapsing during the overmolding of the junction part 5.

Regardless of the embodiment, the injection rail 1 according to the invention comprises at least one rail body 2 having an end 2a to be closed, a plug 3 closing said end 2a of the rail body 2 and a junction part 5 overmolded in the contact area 4 of the assembly of the rail body 2 and of the plug 3 so as to fixedly attach the assembly. This injection rail 1 is illustrated in FIGS. 1 and 2, the junction part 5 and the plug 3 represented in these figures corresponding to the first embodiment.

Regardless of the embodiment and as illustrated in FIG. 4 as example, the rail body 2 comprises an application surface S, S′, on which a fuel pressure may be applied, said application surface S, S′, is a circular surface whose center is arranged on the middle longitudinal axis X-X of the rail body within the inner volume of the rail body. As shown in FIG. 4, when the perimeter of the application surface corresponds to the external diameter of the rail body, the application surface is referred to as S and when the perimeter of the application surface corresponds to the internal diameter of the rail body, the application surface is referred to as S′.

The first embodiment will now be described with reference to FIGS. 1 to 5.

According to the first embodiment, the overmolding area 100 extends around the contact area 4. Furthermore, the overmolding area 100 extends through the contact area 4 via recesses 13 formed on the end 2a of the rail body 2 and the recesses 14 formed on the plug head 3a, as illustrated in FIG. 2. Hence, the junction part 5 is formed only at the outside of the injection rail 1 as illustrated in FIG. 4 and in detail in FIG. 5. The overmolding area 100 is annular.

More specifically and as shown in particular in FIG. 3, the junction part 5 comprises an upper portion 5a lying against the plug head 3a and a lower portion 5b covering the end 2a of the rail body 2 clasping the contact area 4 at the level of which the plug head 3a and a flange of the end 2a of the rail body 2 are in contact. The matter of the junction part 5 crosses the contact area 4 via the recesses 13, 14.

Furthermore, the end 2a of the rail body 2 has a circumferential protruding lug 2b serving as a stop against which bears the lower portion 5b of the junction part 5.

According to the first embodiment, the junction part 5 presents an annular shape.

According to the invention and as illustrated in FIGS. 4 and 5, before injection of the matter of the junction part 5, the plug 3 and the rail body 2 are assembled together. This assembly is held laterally by a first mold metallic portion 201 and by a second mold metallic portion 202 each being arranged at one side of the assembly. Furthermore, the assembly is further held by a third mold metallic portion 203 engaged at least partially into the plug 3. Advantageously, the third metallic portion fits into the plug 3 so as to support the assembly during the overmolding of the junction part 5 in order to avoid the collapse of the assembly under the overmolding pressure.

The second embodiment will now be described with reference to FIGS. 6 and 7.

The second embodiment differs from the first embodiment in that the overmolding area 100 is out of the contact area 4 thereby forming a matter excess or bead 6 on the periphery of the plug 3 and at the same time it is included at the level of the contact area 4 and more specifically between a portion of the end 2a of the rail body 2 and of the plug head 3a as shown in particular in FIG. 7. Thus, the junction part 5 has less contact with the mold portions 201, 202, 203, schematically represented in FIG. 4, which allows preserving the heat of the matter forming the junction part in order to promote the melting of the contact area 4.

In the second embodiment, the injection inlet 101 is formed between the rail body 2 and the plug 3 via at least one recess 10 formed on the rail body 2. Preferably and as shown in FIG. 6, the rail body comprises several recesses 10 so as to enable an inclusion of the matter of the junction part 5 at several places of the assembly.

According to a variant of the second embodiment, the plug body 3b comprises a plurality of crenellations 7 configured to improve the mechanical strength of the assembly. These crenellations 7 are shown in FIG. 7.

According to the second embodiment, the matter excess 6 should be removed by a subsequent mechanical operation at the overmolding step.

According to the second embodiment, the junction part 5 presents a generally annular shape.

The third embodiment will now be described with reference to FIGS. 8 to 10.

The third embodiment differs from the first embodiment in that in order to increase the filling duration, we no longer act on the filling volume as is the case for the first two embodiments but rather on the flow length. Thus, as is the case for the first two embodiments, the injection inlet is located at the level of the contact area 4, but, unlike the first two embodiments, the contact area is located mainly at the level of the internal diameter of the rail body 2.

As shown in FIG. 10, the plug 3 has a hollow projection 8 formed at least partially on the plug body 3b and which extends from a free end of the plug body 3b toward the plug head 3a. In the third embodiment, the projection 8 comprises a plurality of hollow rings 8a, 8b including a primary ring 8a arranged at the level of the free end of the plug body 3b and secondary rings 8b arranged between the primary ring 8a and the plug head 3a. Thus, after overmolding, the junction part presents a generally cylindrical shape formed by rings 12a, 12b including the primary ring 12a the closest to the contact area 4, and secondary rings 12b between the primary ring 12a and the end of the junction part 5, as illustrated in FIGS. 9 and 10.

Furthermore, the rail body 2 comprises a plurality of recesses 9 positioned at least partially opposite the projection 8 formed on the plug.

More particularly, recesses 9 are arranged between two rings 8b of the projection 8 having a plurality of rings. Once filled, the recesses form a junction 11 between said rings 8b.

Advantageously, the more rings there are, the larger is the volume to fill and therefore the time of circulation of the hot matter within the first ring 8a increases. In addition, the longer the length of the flow, the more the pressure within the first ring 8a increases during filling. The pressure tends to promote the heat exchanges with the walls. Hence, the first ring 8a has all the characteristics for melting the contact surfaces: a hot fluid coming directly from the injection screw during the filling period with high pressures which increase the transmission of heat to the walls to melt.

The fourth embodiment will now be described with reference to FIGS. 11 and 12. The fourth embodiment differs from the third embodiment in that the secondary rings form a continuous helix 12c rather than rings 12b connected by junction elements 11. The helix allows having a longer flow than is the case with several rings and for the same bulk and the same mass of injected matter.

Of course, the invention is not limited to the embodiments described and represented in the appended figures and illustrating an injection rail, these embodiments may be applied to any plastic conduit subjected to a high inner relative pressure as explained hereinabove in the description. Modifications are still possible, in particular concerning the constitution of the various elements or by substitution with technical equivalents, yet without departing from the scope of the invention.

1. A plastic injection rail subjected to an inner relative pressure for an engine preferably, wherein the injection rail comprises at least:
a conduit body having an end to be closed;
a plug closing said end of the conduit body, said plug comprising at least a plug body and a plug head;
a junction part overmolded within a contact area defined by a portion of the plug and a portion of the end of the conduit body which are in contact with each other, said junction part being configured to fixedly attach the plug into the end of the body, the junction part comprising at least one first portion arranged around the contact area of the plug and of the conduit body and one second portion included within at least one space created between the conduit body and the plug;
wherein the plug has a hollow projection formed at least partially on the plug body and which extends from a free end of the plug body toward the plug head;
wherein the plug body comprises a plurality of hollow rings including a primary ring arranged at the level of the free end of the plug body and at least a secondary rings arranged between the primary ring and the plug head; and
wherein the junction part presents a generally cylindrical shape formed by rings including a primary ring the closest to the contact area, and at least a secondary rings between the primary ring and the end of the junction part.

2. The plastic injection rail according to claim 1, wherein the conduit body comprises an application surface on which a fluid pressure may be applied, said application surface is a circular surface whose center is arranged on the middle longitudinal axis X-X of the conduit body within the inner volume of the conduit body and whose perimeter corresponds to a diameter of the conduit body.

3. The plastic injection rail according to claim 1, wherein the rail body comprises a plurality of recesses positioned at least partially opposite the projection formed on the plug.

4. The plastic injection rail according to claim 3, wherein the recesses are arranged between two rings of the projection having a plurality of rings.

5. The plastic injection rail according to claim 4, the recesses form a junction between said rings.

6. The plastic injection rail according to claim 1, wherein the secondary rings form a continuous helix.
